(19) United States
(12) Patent Application Publication
(10) Pub. No.: US 2007/0235652 A1
(43) Pub. Date: Oct. 11, 2007

(54) Weapon detection processing

(76) Inventor: Steven Winn Smith, Poway, CA (US)

Correspondence Address: Steven W. Smith, 10907 Technology Place, San Diego, CA, 92127, US

(21) Appl. No.: 11/400,823

(22) Filed: Apr. 10, 2006

(51) Int. Cl. G01N 23/04; G01T 1/161

(52) U.S. Cl. 250/363.02; 378/62

(57) ABSTRACT

A radiant energy imaging system is used to create an electronic image of a person entering a security controlled area to detect weapons or contraband concealed under their clothing. The electronic image is electronically transmitted to a processing center where it is evaluated by a human and/or software algorithms for the presence of concealed objects. The resulting evaluation, consisting of digitally represented information, is electronically transmitted back to the examination site. In one embodiment this processed data is displayed as a graphical outline of the concealed objects superimposed on an optical image of the person. In another embodiment, the processed data is used to control a personnel barrier controlling access into the security controlled area. In another embodiment a network allocation server selectively routes the electronic images from two or more body scanners to two or more processing centers.

### BACKGROUND OF THE INVENTION

This invention relates to the transmission, evaluation, and display of electronic images used to detect weapons concealed under persons' clothing.

Over the last 20 years a variety of radiant energy imaging systems have been developed to detect weapons, explosives and contraband concealed under the clothing of persons entering security controlled areas. All of these systems operate by detecting radiant energy that has been modulated by or emitted from the body of the person being examined. Radiant energies used include: x-rays, microwaves, millimeter waves, infrared light, terahertz waves, and ultrasound. These radiant energies may be reflected from near the body surface, transmitted entirely through the body, or emitted from the body as thermal radiation. Commercial systems include the model SECURE 1000, sold by Rapiscan Security Products, Hawthorne, Calif.; model SmartCheck, sold by American Science and Engineering, Billerica, Mass., model TADAR, sold by Smith's Detection, Cork, Ireland; model SafeScout, sold by SaveView, Santa Clara, Calif., and model Conpass, sold by MMC International, Breda, The Netherlands. These radiant energy imaging systems that are used to detect objects concealed under the clothing are often referred to simply as “body scanners.”

In spite of using different radiant energies and imaging geometries, these body scanners detect concealed objects in the same fundamental way: they create an electronic image of the person with the clothing being essentially transparent. This electronic image is displayed on a monitor, either mounted directly on the scanning apparatus or located in close proximity, for inspection by a security officer. The security officer evaluates the displayed image through his innate and trained ability to recognize the normal visual appearance of the human body. That is, the security officer knows what the unclothed human body looks like and can therefore detect objects appearing in the displayed image that do not correspond to human anatomy. In addition, from his training and experience in society, the security officer can often recognize which of the concealed objects are benign and need no investigation, such as wallets, watches, coins, buttons on the clothing, and so on. If the security officer observes an object that is not a part of the subject's body, and is not recognized as being benign, the security officer confronts the subject to determine if the object is a prohibited item. This may be as simple as asking the subject to remove the item from within their clothing, or as invasive as a strip search. The method of resolution depending on the characteristics of the object observed and the security facility being entered.

Body scanners are capable of detecting a wide range of security threats and contraband; however, the required image interpretation presents a multitude of problems and difficulties. The manpower requirements to operate these systems is very high, since a security officer must be present at each unit during its operation. This is aggravated by the specialized training each security officer must go through to be proficient in the image analysis. The large number of security officers operating these systems, and the nature of this work, promotes errors and deficiencies in the security screening process. For instance, security officers may become distracted or tired and miss concealed objects. In a worse scenario, a security officer may be bribed or threatened to ignore concealed objects. Further, the routine presence of a security officer at each system requires that the examination area be large enough to accommodate the security officer. Further, the presence of the security officer unnecessarily slows the processing speed in the common case where no concealed objects are present. Still further, many subjects express objection to an electronic image of their unclothed body being displayed and viewed by the security officer dealing with them. Even further, the distributed and independent operation of prior art body scanners prevents the centralized storage and access of electronic data related to security screening procedures.

### BRIEF SUMMARY OF THE INVENTION

The invention overcomes these limitations of the prior art by providing for one or more centralized image processing centers, with each processing center serving a multitude of body scanners. A bidirectional digital communications channel is provided between each body scanner and each processing center, such as a dedicated connection, a local area network, a wide area network, or the internet. The electronic image generated from each scanning cycle of each body scanner is transmitted to one of the processing centers where it is evaluated for the presence of concealed objects. This evaluation may be performed by software algorithms, human examination of the electronic image, or a combination of the two. The results of this evaluation are electronic data that are transmitted back to the originating body scanner. In one preferred embodiment these electronic data are a graphic showing the shape and location of the detected concealed objects. These graphical data are displayed to the on-site security officer with positional reference, such as overlaying on an optical image of the subject or in relation to a graphical outline of the subject's body. In another preferred embodiment, these electronic data are computer codes that enable or disable the opening of barriers controlling the access of the subject into the security controlled area.

It is therefore the goal of the invention to provide an improved method and apparatus for detecting security threats and contraband concealed under the clothing of persons entering security controlled areas. Another goal of the invention is to reduce the manpower required to operate a multitude of body scanners. Yet another goal is to improve the quality and reliability of image evaluation of body scanners. Yet another goal is to prevent the image evaluation process from being compromised by bribe or threat. Still another goal is to reduce the physical space requirements around body scanners. A further goal is to improve the overall processing speed of body scanner images. A still further goal is to eliminate the potential embarrassment of subjects being screened by body scanners.

### BRIEF DESCRIPTION OF THE DRAWINGS

FIG. 1 is a schematic depiction of the prior art body scanners.

FIG. 2 is example images produced by prior art body scanners.

FIG. 3 is a schematic depiction in accordance with the present invention.

FIG. 4 is annotated images in accordance with the present invention.

FIG. 5 is a graphic in accordance with the present invention.

FIG. 6 is a graphic in accordance with the present invention.

FIG. 7 is a schematic diagram in accordance with the present invention.

FIG. 8 is a flowchart in accordance with the present invention.

### DETAILED DESCRIPTION OF THE INVENTION

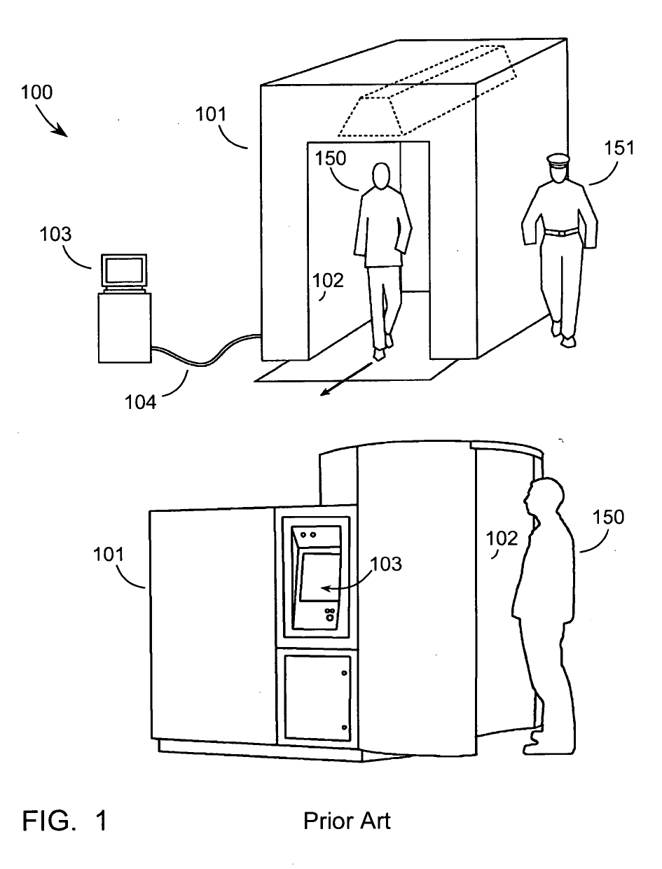

FIG. 1 shows two examples of prior art radiant energy imaging systems used to detect security threats and contraband concealed under the clothing of persons entering security areas. Commonly called “body scanners,” these systems are well known in the art and marketed by a variety of companies, as previously described. The overall body scanner 100 consists of an enclosure 101 that contains the radiant energy detector and, if needed, the radiant energy illuminator. One area on the exterior of the enclosure 101 is the imaging location 102, which is where the subject 150 being screened is positioned for the screening process. During this process the subject may be required to remain stationary, or may be allowed to walk through or by the apparatus, depending on the type of body scanner being used. The image acquisition process typically lasts a few seconds, at which time the electronic image produced by the body scanner is displayed on a computer monitor 103. The monitor 103 may be mounted directly on the body scanner enclosure 101, or positioned in close proximity using an electronic video cable 104. The security officer 151 manning the body scanner views the electronic image displayed on the monitor 103 to determine if concealed objects are present under the clothing of the subject 150.

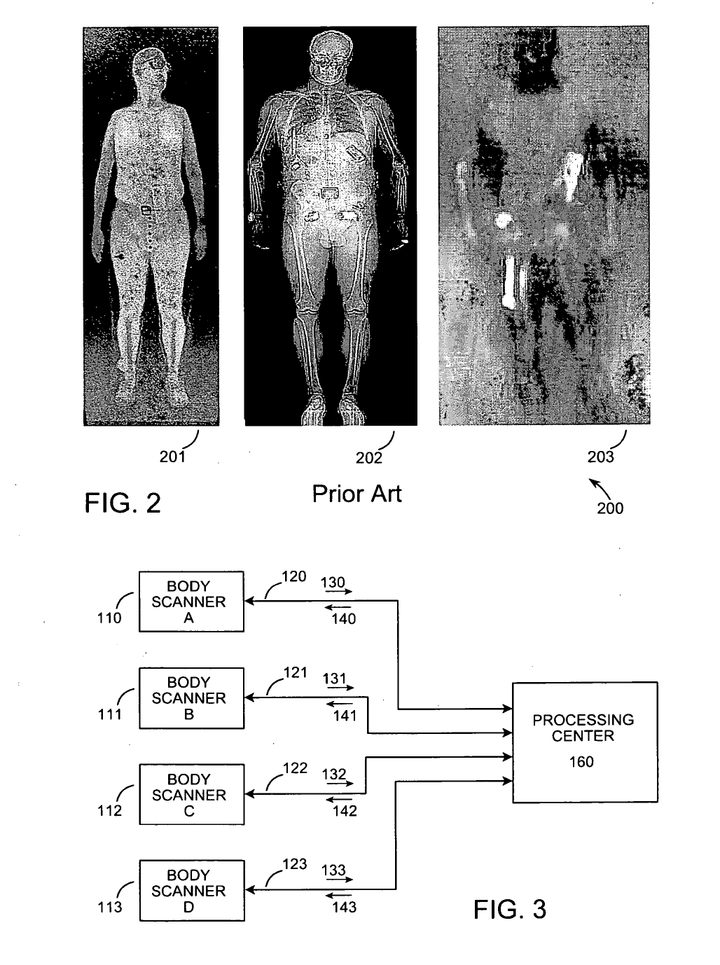

FIG. 2 shows examples of prior art electronic images 200 taken with three different body scanners using three different types of radiant energy. The left image 201 was created by using x-rays that are back-scattered, i.e., reflected, from near the surface of the body. Accordingly, this image 201 essentially shows the surface of the body and does not reveal any of the subject's internal anatomy. In comparison, the center image 202 was created by using x-rays that are transmitted completely through the subject's body, and therefore shows the bones and other internal organs. Both these techniques operate by exposing the subject to radiant energy, in this case x-ray radiation, that is actively emitted by the body scanner. The image on the right 203, in contrast, was created by detecting millimeter waves that occur naturally, and does not expose the subject to any man-made radiation. As well known in the art, these electronic images 200 are digital data held in a computer memory or similar digital electronics, and are encoded according to a storage standard such as bmp, jpg, tiff, gif, or similar. As also well known in the art, these electronic images 200 can be transmitted, manipulated, and displayed in a variety of ways.

The images in FIG. 2 demonstrate that the different types of body scanners have very different inherent detection capabilities. Irregardless, they all operate by displaying an electronic image for evaluation by a human operator at the body scanner site. As known to those skilled in the art of digital image processing, it is not currently possible for software algorithms to completely take the place of this human evaluation. The human visual system and brain are far superior in this respect to the best computerized image analysis tools available today. Software routines may be useful for detecting some obvious objects, such as metal handguns; however, they cannot reliably detect the full range of concealed objects that appear in body scanner images.

FIG. 3 shows one preferred embodiment of the present invention. A number of body scanners, exemplified by body scanner A 110, body scanner B 111, body scanner C 112 and body scanner D 113, are connected through bidirectional digital communication channels 120, 121, 122, 123, respectively, to processing center 160. The processing center 160 may be physically located anywhere other than the site of body scanners 110-113. For instance, it may be located in the next room, or in a distant part of the world, as long as the communication channels 120-123 can be established. Each time a body scanner 110-113 scans a subject, the resulting electronic image 200 is transmitted over the respective communication channel 120-123 as a stream of digital data 130, 131, 132, 133, respectively, to the processing center 160. In the processing center 160 the electronic image 200 is converted into processed data, which is transmitted back to the originating body scanner over the respective communication channel 120-123 as a stream of digital data 140, 141, 142, 143, respectively. In this manner, each body scanner transmits an electronic image it acquires to the processing center, and subsequently receives from the processing center processed data concerning said electronic image.

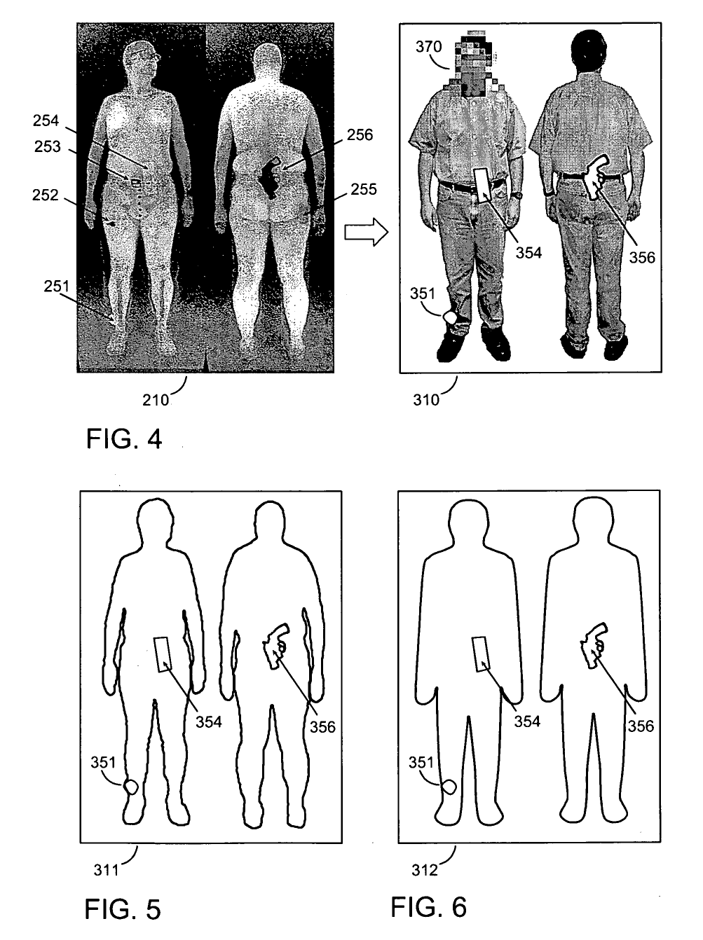

FIG. 4 further explains the operation of one preferred embodiment of the present invention. An example electronic image 210 created by a body scanner shows a variety non-anatomic objects on the subject. This particular example electronic image 210 was created by using back-scattered x-rays and consists of a front scan and a rear scan, with metal objects appearing in black and organic objects appearing in white. Visual inspection shows a round organic object 251 on the ankle; a metal key 252 in the pants' pocket; a metal belt buckle 253 and metal buttons on the fly of the pants; a rectangular organic object 254 in the front waistband, a rectangular object resembling a wallet 255 in the rear pants pocket; and a metal handgun 256 in the rear waistband. In accordance with the present invention, this example image 210 is transmitted to the processing center. A human operator at the processing center displays the example image 210 on a computer monitor and examines it for concealed objects. Using computer graphics tools that are well known in the art, the human operator creates a graphical representation of those objects that are not anatomic and are not recognizable as being benign. In the example shown in FIG. 4, the human operator would recognize the key 252, the belt buckle 253 and the wallet 255 as not being dangerous and therefore ignore them. On the other hand, the human operator would recognize the two organic objects 251, 254 as being potential weapons, explosives, contraband or other prohibited items. Likewise, the distinctive outline of the handgun 256 would be recognized by the human operator as being a weapon. In one embodiment, the human operator would use a computer mouse or similar pointing device to outline the object of interest. This creates the graphical representations of the three objects of interest 251, 254, 256 as black outlines with white centers 351, 354, 356, respectively. In this preferred embodiment the processed data consists of the digital data needed to represent the graphical object outlines 351, 354, 356, which is transmitted to the body scanner that created the original electronic image.

FIG. 4 additionally shows one embodiment where the processed data are superimposed on an optical image of the subject to form a composite image 310. The optical image is acquired be using a conventional digital camera mounted on the body scanner to take a snap shot image at some time during the scanning procedure. As known in the art, the optical image from the digital camera can be digitally combined with the graphical representation prepared at the processing center to create the composite image 310 shown in FIG. 4. Within the scope of the invention, this combination can be performed by the body scanner or at the processing center. In one embodiment, the face 370 of the person in the optical image is made unrecognizable by one of the many techniques known in the art of image processing. As thus can be seen from FIG. 4, the present invention provides for the electronic image 210 generated by the body scanner to be manipulated into a composite image 310, formed from an optical image with superimposed graphical objects. The composite image 310 is then displayed on the body scanner monitor 103 in the place of the electronic image 210.

FIGS. 5 and 6 shows other preferred embodiments where the graphical objects 351, 354, 356 are combined with outlines of the subject to form the composite images 311, 312, respectively. The outline of the subject can be derived from the electronic image 210 by the use of edge detection algorithms that are well known in the art. This embodiment has the advantage of increased privacy for the subject, while still providing a display that indicates the location of the concealed objects on the subject. In another embodiment, a generic outline of a human body can be combined with the graphical object outlines 351, 354, 356 to create another type of composite image 312. This embodiment has even greater privacy for the subject since even the outline of their body is not displayed at the body scanner location. The image processing and graphical techniques needed for a human operator to convert an electronic image 210 into one of these composite images 310, 311, 312 are well known in the art.

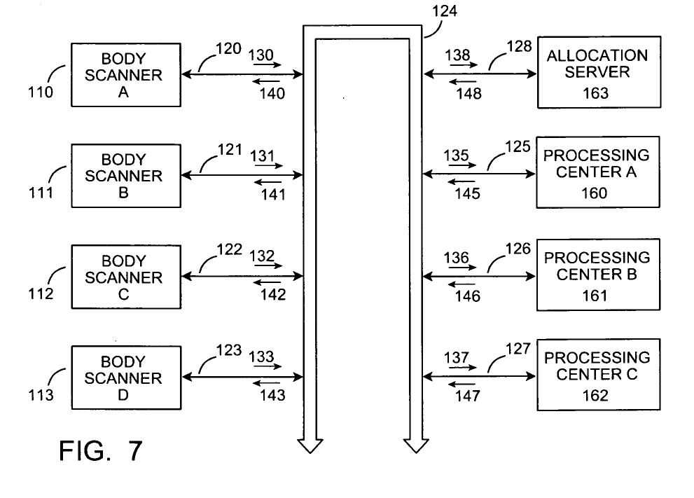

From the above description those skilled in the art will recognize that many variations are possible within the scope of the present invention. FIG. 7 shows one preferred embodiment where the digital communication between a multitude of body scanners and a multitude of processing centers is implemented in a network configuration. As before, body scanners A-D 110-113 transmit their electronic images 130-133 and receive the corresponding processed data 140-143 over communication channels 120-123, respectively. Likewise, processing centers A-C 160-162 receive the electronic images 135-137 and transmit the processed data 145-147 over communication channels 125-127, respectively. Communication network 124 connects the communication channels 120-123 for the body scanners with the communication channels 135-137 for the processing centers. As known in the art, communication network 124 can be a local area network, a wide area network, or the internet. It will be clearly understood by those skilled in the art that each body scanner 110-113 and each processing center 160-162 contains a digital processor or computer to enable this communication and that the details of this digital data exchange are common place in the art of network communication. In the network embodiment illustrated by FIG. 7, each body scanner and processing center has a unique network identifier, allowing any one of these to send digital data to any other. In one embodiment, each body scanner is preprogrammed to communicate with only one processing center. In a preferred embodiment, the electronic image from each body scanner is routed to a processing center by computer algorithms that tend to equalize the work load of the processing centers. This can be accomplished by the use of an allocation server 163 attached to the network 124 by communication channel 128, transmitting digital data 148 and receiving digital data 138.

In one embodiment, each processing center 160-162 periodically sends its available processing capability to the allocation server 163. In this embodiment, each body scanner 110-113 transmits its electronic image to the allocation server 163, which in turn relays this electronic image to the processing center with the most processing capability.

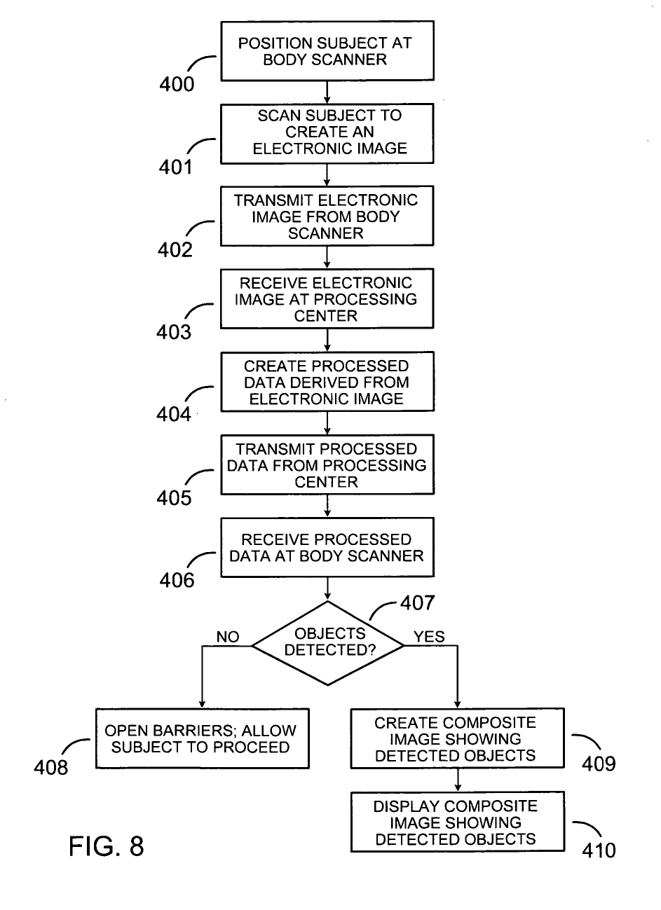

Those skilled in the art of digital communications networks will clearly see that many prior art communication configurations can be used in the present invention. For instance, the allocation server 163 can periodically send digital information to each body scanner 110-113 assigning which processing center is to be used, such that the electronic image can then be sent directly from the body scanner to the indicated processing center. In a preferred embodiment, redundant allocation servers are provided to insure that the bulk of the system remains operable even if there are computer or communication channel failures. The flow graph of FIG. 8 further defines the invention. In one preferred embodiment the invention consists of a method to carry out the following steps. The subject is positioned 400 in the imaging area of a body scanner. The body scanner scans 401 the subject to create an electronic image that essentially shows the subject's clothing as being transparent. The body scanner transmits 402 the electronic image over a communication channel. The electronic image is received 403 at a processing center over the communication channel. Processed data is created and derived 404 from the electronic image, wherein the processed data is an electronic description of the concealed objects appearing in the electronic image. The processed data is transmitted 405 from the processing center over the communication channel. The processed data is received at the body scanner 406 over the communication Weap channel. The method and apparatus for transmitting and receiving these digital data are well known, comprising digital computers and enabling software. The body scanner examines the processed data and takes one of two actions 407 depending on if the processed data indicates that there are concealed objects. If there are concealed objects, the body scanner creates a composite image 409 showing a graphical representation of the objects plus a representation of the subject's body forpositional reference. The body scanner displays 410 this composite image on a monitor mounted on the body scanner or in close proximity. In the event that the processed data indicates that no concealed objects are present 407, the body scanner energizes mechanical actuators that allow the subject to proceed 408 into the security controlled area, such as releasing the lock on a door, raising a stop-bar, illuminating a text message to the subject, and/or similar measures.

As thus described, the invention provides an improved method and apparatus for detecting security threats and contraband concealed under the clothing of persons entering security controlled areas. The invention overcomes a multitude of problems and limitations of the prior art. For instance, the prior art requires one security operator to be stationed at each body scanner to interpret the electronic images. However, these security operators spend most of their time waiting for the subjects to position themselves and the scans to be conducted. Only a fraction of their time is actually spent in examining the images. The present invention replaces this one-for-one match of security officers with a far fewer number of human image evaluators at the processing center, thereby reducing the manpower required to operate a multitude of body scanners. In a typical case, each human image evaluator can replace three to six on-site security officers. This smaller number of personnel also allows for greater training and supervision, improving the quality of the image interpretation process. Another advantage of the present invention is that the electronic images are being evaluated by personnel that are dedicated only to this task and isolated from distracting events at the body scanner site. Further, in a preferred embodiment, the stream of electronic images generated from any one body scanner are evaluated by different processing centers and different personnel within the processing centers. That is, the match up between the body scanners and the processing centers is selected by the allocation server on a second-by-second basis. Accordingly, it would be impossible for a criminal or terrorist to threaten or bribe the image evaluation personnel at the processing center to allow weapons or contraband to be smuggled pass one particular body scanner. In comparison, the prior art is extremely vulnerable in this respect, as one on-site security officer is paired with one body scanner. Another advantage is that the physical space around the body scanner can be reduced, since the security officer no longer needs to continually man the body scanner. A further advantage of the present invention is that persons being screened are afforded much greater privacy by not displaying their unclothed image at the body scanner location.

The above specific descriptions and embodiments have been made to explain the invention and those skilled in the art will immediately recognize that other embodiments and modifications are within the scope of the invention. The body scanner can operate by detecting various forms of radiant energy, including ultrasound, microwaves, millimeter waves, infrared light, x-rays and gamma rays. This radiant energy can be transmitted through the subject, scattered from the subject, or emitted by the subject. The electronic image generated by the body scanner as a result of detecting radiant energy can be of various pixel sizes, such as from 50 by 50 pixels to 5,000 by 5,000 pixels, and may use only a single bit to represent each pixel, or 32 or more bits per pixel. The electronic images may be black and white, grayscale, or color. Further, the electronic images may be two-dimensional or contain three-dimensional information.

The communication channel connecting one or more body scanners with one or more processing centers may consist of one or more dedicated lines, a local area network, a wide area network, the internet, or any combination of these. Likewise, it may consist entirely or partially of point-to-point wired connections, fiber optics, ground based radio links, satellite transmissions, free space optics, and other digital communication methods known now and which may be developed in the future. As well known in the art of network communication, the exchange of digital information between the body scanners and the processing centers may involve secondary exchanges of digital information, such as needed to establish and maintain the communication channel, insure reliability and redundancy, and improve efficiency. These provisions are also within the scope of the present invention, as can be clearly recognized by those skilled in the art.

The processing center or centers may be located near the body scanner or body scanners, such as in the next room or next building, or located in distant corners of the world. As provided for in the invention, the processing centers only need to be physically separated from the body scanners such that: the electronic images displayed at the processing centers are not visible to the subjects and personnel at the body scanner site; the activities of the processing center are not requiring physical space around the body scanner; there is no on-going personal interaction between the persons at the body scanner site and the persons at the processing center; at so on. Each processing center may consists of only a single human operator, or thousands of human operators, along with the required computers, electronics, software, and so on, to carry out the processing of the electronic images into the processed data. As know in the art of image processing, software tools may be used by the human operators to reduce the time needed to process each electronic image. This includes software tools for finding edges, detecting regions of similar characteristics, tracing the outline of objects, and so on. This includes user interface hardware such as mouses, light pens, touch screens, and the like, as well known in the art of digital computers.

The processed data generated by the human operator may include graphical information, text descriptions, image thumbnails, grayscale and color image segments, or combinations thereof, represented by digital data. Concealed objects may be represented in the processed data by relative or absolute coordinates, size and shape information and parameters, metal versus organic discrimination, and other methods known in the art of image processing and the art of security imaging systems. In one preferred embodiment the processed data consists of only a short descriptive computer code in the common event of no concealed objects being detected. The processed data may include a positional reference to the subject's body, such as an optical image, an outline of the subject's body derived from either the electronic image or the optical image, or a generic humanoid outline. In other embodiments these positional references may be combined with the processed data at the body scanner to create a composite image for display. Likewise, at the body scanner the processed data may be directly displayed as an image, operate gates or other barriers, electronically alert security officers, and so on. In another important preferred embodiment, the location of the body scanner is separated from the location of the security officer by a hundred feet or more, as needed to protect the security officer in the event of a suicide bomber. In this embodiment the electronic image is generated at the location of the body scanner, while the processed data is returned to the location of the security officer manning the body scanner, which is in the same general vicinity but located a safe distance away.

Although particular embodiments of the invention have been described in detail for the purpose of illustration, various other modifications may be made without departing from the spirit and scope of the Invention. Accordingly, the invention is not to be limited except as by the appended claims.

I claim:

1. A method of detecting an object concealed under the clothing of a person, comprising:
operating a body scanner to create an electronic image of said person wherein the clothing of said person is substantially transparent;
transmitting said electronic image over a communication channel; and
receiving processed data over said communication channel wherein said processed data is derived from said electronic image and representative of said object.

2. The method of claim 1, wherein said communication channel comprises a digital communication network.

3. The method of claim 1, wherein said processed data comprises a graphical representation of said object in positional reference to the body of said person.

4. The method of claim 3, further comprising displaying said graphical representation superimposed on an optical image of the body of said person.

5. The method of claim 3, further comprising displaying said graphical representation superimposed on a graphical outline of the body of said person.

6. The method of claim 3, wherein said communication channel is the internet.

7. The method of claim 1, further comprising activating a movable barrier in response to said processed data thereby allowing said person to enter a security restricted area.

8. An apparatus for detecting an object concealed under the clothing of a person entering a security controlled area, comprising:
body scanner means for creating an electronic image of said person and said object;
communication means for transferring electronic data;
transmission means for transmitting said electronic image over said communication means;
processing means for converting said electronic image into a processed data set;
reception means for receiving said processed data set from said communication means; and
display means for presenting said processed data set.

9. The apparatus of claim 8 wherein said communication means comprises the internet.

10. The apparatus of claim 8 wherein said processing means comprises a human operator viewing said electronic image and generating a graphical representation of said object.

11. The apparatus of claim 8 further comprising a personnel barrier, said personnel barrier controlling the access of said person into said security controlled area, said personnel barrier being actuated in response to said processed data set.

12. The apparatus of claim 10 wherein said communication means comprises the worldwide internet.

13. The apparatus of claim 8 wherein said display means comprises a computer monitor showing a graphical representation of said object derived from said processed data set in a positional reference to the body of said person.

14. The apparatus of claim 13 wherein said positional reference comprises an optical image of the body of said person.

15. The apparatus of claim 14 wherein said communication means comprises the internet.

16. An apparatus for searching persons, comprising:
a first body scanner for creating a first electronic image of a first person;
a second body scanner for creating a second electronic image of a second person;
a first processing center for evaluating the electronic images created by the body scanners;
a second processing center for evaluating the electronic images created by the body scanners;
a digital communication network connecting said first body scanner and said second body scanner with said first processing center and said second processing center; and
an allocation server for selectively routing said first electronic image and said second electronic image to said first processing center and said second processing center.

17. The apparatus of claim 16 wherein said digital communication network is the internet.

18. The apparatus of claim 16 wherein said first processing center comprises a first human image evaluator and said second processing center comprises a second human image evaluator.

19. The apparatus of claim 16 wherein said first body scanner comprises a first processed data display means, and said second body scanner comprises a second processed data display means.

20. The apparatus of claim 19 wherein said digital communication network is the internet.
